(19) United States
(12) Patent Application Publication
(10) Pub. No.: US 2024/0421358 A1
(43) Pub. Date: Dec. 19, 2024

(54) ALL-SOLID-STATE BATTERY AND METHOD FOR PRODUCING SAME

(71) Applicant: Panasonic Intellectual Property Management Co., Ltd., Osaka (JP)

(72) Inventors: SHUZO TSUCHIDA, Nara (JP); TOSHIYUKI KOJIMA, Kyoto (JP)

(21) Appl. No.: 18/817,288

(22) Filed: Aug. 28, 2024

Related U.S. Application Data
(63) Continuation of application No. PCT/JP2022/045209, filed on Dec. 8, 2022.

(30) Foreign Application Priority Data
Mar. 10, 2022 (JP) 2022-037473

(51) Int. Cl. H01M 10/0585; H01M 4/02; H01M 4/133; H01M 4/1393; H01M 4/36; H01M 4/62

(52) U.S. Cl. CPC H01M 10/0585; H01M 4/133; H01M 4/1393; H01M 4/366; H01M 4/62; H01M 2004/027; H01M 2300/0065

(57) ABSTRACT

All-solid-state battery (100) has a structure in which positive electrode current collector (7), positive electrode layer (20) including positive electrode active material (2) and solid electrolyte (1), solid electrolyte layer (10) including solid electrolyte (5), negative electrode layer (30) including negative electrode active material (3) and solid electrolyte (4), and negative electrode current collector (8) are stacked in this order. Negative electrode active material (3) includes a plurality of flat active material particles having a structure of a plurality of stacked pieces of graphite. Negative electrode layer (30) has, in a cross section, active material orientation region (14) including two or more of a plurality of flat active material particles that are adjacently oriented. The major axis of each of the two or more flat active material particles has an angle of 0° or more and 30° or less with respect to the thickness direction of negative electrode layer (30).

### TECHNICAL FIELD

The present disclosure relates to an all-solid-state battery and a method for producing an all-solid-state battery, particularly to an all-solid-state battery including a positive electrode layer, a negative electrode layer, and a solid electrolyte layer, and a method for producing such an all-solid-state battery.

### BACKGROUND ART

In recent years, electronic devices such as personal computers and mobile phones have become more light-weight and cordless, and development of repeatedly usable secondary batteries has been needed. Examples of secondary batteries include a nickel cadmium battery, a nickel hydrogen battery, a lead storage battery, and a lithium ion battery. Among these secondary batteries, the lithium ion battery has features such as light weight, high voltage, and high energy density, and has attracted attention.

Development of secondary batteries having high battery capacity is emphasized also in the field of automobiles such as electric vehicles and hybrid vehicles, and the demand for lithium ion batteries has shown an increasing trend.

The lithium ion battery includes a positive electrode layer, a negative electrode layer, and an electrolyte disposed therebetween. As an electrolyte, for example, an electrolytic solution that is an organic solvent in which a supporting electrolyte such as lithium hexafluorophosphate is dissolved or a solid electrolyte is used. A lithium ion battery that is currently widely available includes an electrolytic solution containing organic solvent and is thus flammable. So that a material, a structure, and a system for securing safety of the lithium ion battery are necessary. Meanwhile, use of a non-flammable solid electrolyte may enable simplification of the material, structure, and system, and may increase energy density, reduce production cost and improve productivity. Hereinafter, a battery including a solid electrolyte, such as a lithium ion battery including a solid electrolyte that conducts lithium (Li) ions, will be referred to as an “all-solid-state battery”.

Solid electrolytes can be broadly categorized into organic solid electrolytes and inorganic solid electrolytes. Typical inorganic solid electrolytes include oxide solid electrolytes, sulfide solid electrolytes, and halide solid electrolytes. The sulfide solid electrolyte and the halide solid electrolyte have smaller grain boundary resistance than the oxide solid electrolyte, and thus can obtain good characteristics by solely compression-molding a powder without a sintering process. In recent years, for the development of all-solid-state batteries having further larger size and capacity, research on coated-type all-solid-state batteries in which a sulfide solid electrolyte is used to make the battery large has been eagerly made.

As a method for producing an all-solid-state battery, PTL 1 discloses a method of producing a negative electrode layer by pressure-molding a mixture of negative electrode active material particles and solid electrolyte particles.

### CITATION LIST

### Patent Literature

PTL 1: Unexamined Japanese Patent Publication No. H8-138724

### SUMMARY OF THE INVENTION

An all-solid-state battery according to one aspect of the present disclosure includes a positive electrode current collector, a positive electrode layer including a positive electrode active material and a first solid electrolyte, a solid electrolyte layer including a third solid electrolyte, a negative electrode layer including a negative electrode active material and a second solid electrolyte, and a negative electrode current collector, the positive electrode current collector, the positive electrode layer, the solid electrolyte layer, the negative electrode layer, and the negative electrode current collector being stacked in this order, in which the negative electrode active material includes a plurality of flat active material particles each having a structure of a plurality of stacked pieces of graphite, the negative electrode layer has an active material orientation region including two or more flat active material particles, among the plurality of flat active material particles, that are adjacently oriented along a thickness direction of the negative electrode layer in a cross section of the negative electrode layer, and in the cross section, an angle between a major axis direction of each of the two or more flat active material particles and the thickness direction of the negative electrode layer is 0° or more and 30° or less.

A method for producing an all-solid-state battery according to one aspect of the present disclosure is a method for producing the all-solid-state battery described above, in which a production step of producing the negative electrode layer includes a mixing step of mixing the negative electrode active material and the second solid electrolyte, the mixing step including forming of a covering layer made of the second solid electrolyte using the negative electrode active material including a plurality of active material particles each having a major axis direction and a minor axis direction, having a non-true spherical shape, and having been granulated from a plurality of stacked pieces of graphite, the covering layer covering a major axis directional end of two or more of the plurality of active material particles.

### BRIEF DESCRIPTION OF THE DRAWINGS

FIG. 1 is a schematic view illustrating a cross section of an all-solid-state battery according to an exemplary embodiment.

FIG. 2 is a schematic diagram for explaining a method for producing the all-solid-state battery according to the exemplary embodiment.

FIG. 3 is a flowchart showing a method for producing a negative electrode mixture according to the exemplary embodiment.

FIG. 4 is a flowchart showing a method for producing a negative electrode mixture according to a comparative example.

FIG. 5 is a schematic view for explaining state changes of a negative electrode active material and a solid electrolyte according to the comparative example.

FIG. 6 is a schematic view for explaining state changes of a negative electrode active material and a solid electrolyte according to the exemplary embodiment.

FIG. 7 is an electron microscope image showing an appearance of the negative electrode mixture according to the exemplary embodiment.

FIG. 8 is an electron microscope image showing a cross section of a negative electrode layer according to the exemplary embodiment.

FIG. 9 is a schematic view for explaining state changes of the negative electrode active material and the solid electrolyte in a mixing step according to the exemplary embodiment.

### DESCRIPTION OF EMBODIMENT

(How one exemplary embodiment of the present disclosure has been obtained) The present inventors have found that the following problems occur in the conventional all-solid-state battery described in the “BACKGROUND ART”.

Mostly in general, active materials are handled as granulated particles formed of a plurality of pieces to improve fluidity or the like of the active material so that the production step of a battery will be stable. However, when granulated particles of a plurality of stacked pieces of graphite are used as negative electrode active material particles, the method disclosed in PTL 1 has two problems described below.

The first problem is that the granulated particles inhibit conduction of lithium ions. Specifically, when negative electrode active material particles and solid electrolyte particles are mixed and then pressurized, for example, in a mold, the granulated particles for the negative electrode active material are deformed into flat-shaped active material particles. These flat-shaped active material particles in the negative electrode layer are likely to inhibit, due to the flat shape thereof, conduction of lithium ions in the thickness direction of the negative electrode layer to reduce battery capacity. The reduction in battery capacity is likely to occur, in particular, when charge and discharge are performed at high rate.

The flat-shaped active material particle here is a compact active material composed of oriented and stacked pieces of graphite formed into a flat shape by pressing a non-true spherical active material particle granulated from a plurality of randomly stacked pieces of graphite. Hereinafter, the flat-shaped active material particle is referred to as “flat active material particle”.

The second problem is that the flat active material particles of the negative electrode active material expand and contract in the negative electrode layer by charge and discharge, which causes peeling in the negative electrode layer and at a boundary between the negative electrode layer and the solid electrolyte layer. Peeling reduces ion conduction paths, and thus reduces the battery capacity.

In view of the above problems, the present disclosure provides an all-solid-state battery and the like that have capability of suppressing reduction in battery capacity even when a negative electrode active material including flat active material particles is used.

### Summary of the Present Disclosure

The summary of one aspect of the present disclosure will be described below.

An all-solid-state battery according to one aspect of the present disclosure includes a positive electrode current collector, a positive electrode layer including a positive electrode active material and a first solid electrolyte, a solid electrolyte layer including a third solid electrolyte, a negative electrode layer including a negative electrode active material and a second solid electrolyte, and a negative electrode current collector, the positive electrode current collector, the positive electrode layer, the solid electrolyte layer, the negative electrode layer, and the negative electrode current collector being stacked in this order, in which the negative electrode active material includes a plurality of flat active material particles each having a structure of a plurality of stacked pieces of graphite, the negative electrode layer has an active material orientation region including two or more flat active material particles, among the plurality of flat active material particles, that are adjacently oriented along a thickness direction of the negative electrode layer in a cross section of the negative electrode layer, and in the cross section, an angle between a major axis direction of each of the two or more flat active material particles and the thickness direction of the negative electrode layer is 0° or more and 30° or less.

Since there is the active material orientation region in which the flat active material particles are oriented at small angles to the thickness direction, lithium ion conduction is less likely to be hindered by the flat active material particles, and thus a lithium ion conduction path along the thickness direction in the negative electrode layer can be secured. This suppresses reduction in battery capacity.

For example, it may be configured that the negative electrode layer further includes a solid electrolyte region not including the negative electrode active material but including the second solid electrolyte. The solid electrolyte region is located adjacent to the active material orientation region in the cross section, and has an area of 1.5 times or more of an average area of the two or more flat active material particles in the cross section.

With this configuration, the stress produced by expansion and contraction of the negative electrode active material during charge and discharge can be moderated by the solid electrolyte region. This suppresses peeling in the negative electrode layer and at the boundary between the negative electrode layer and the solid electrolyte layer.

For example, in the cross section, an aspect ratio that is a ratio of a length in a major axis direction to a length in a minor axis direction of at least one flat active material particle among the two or more flat active material particles may be three or more.

With this configuration, lithium ions can easily penetrate into the graphite constituting the flat active material particle from the surface thereof, and thus the negative electrode active material can be used effectively to improve the battery capacity.

For example, a volume ratio of the negative electrode active material to the total volume of the negative electrode active material and the second solid electrolyte in the negative electrode layer may be 46% or more and 96% or less, or 56% or more and 75% or less.

With this configuration, the lithium ion conduction path which the solid electrolyte provides and the electron conduction path which the negative electrode active material provides in the negative electrode layer are both readily provided.

For example, the concentration of the solvent included in the negative electrode layer may be 50 ppm or less.

With this configuration, the negative electrode layer contains substantially no solvent, so that deterioration of the material of the negative electrode layer is suppressed.

A method for producing an all-solid-state battery according to one aspect of the present disclosure is a method for producing the all-solid-state battery described above, in which a production step of producing the negative electrode layer includes a mixing step of mixing the negative electrode active material and the second solid electrolyte, the mixing step including forming of a covering layer made of the second solid electrolyte using the negative electrode active material including a plurality of active material particles each having a major axis direction and a minor axis direction, having a non-true spherical shape, and having been granulated from a plurality of stacked pieces of graphite, the covering layer covering a major axis directional end of two or more of the plurality of active material particles.

With this configuration, the covering layer covers the ends of the non-true spherical active material particle and serves as a support to suppress overturning of the active material particle in the negative electrode layer, and thus the all-solid-state battery having the active material orientation region can be produced easily.

For example, the mixing step may be a step of mixing the negative electrode active material and the second solid electrolyte with compressive force and shear force being applied to the negative electrode active material and the second solid electrolyte.

With this configuration, a dense covering layer can be formed of the second solid electrolyte at the major axis directional end of the active material particle granulated from the negative electrode active material.

Hereinafter, an all-solid-state battery according to an exemplary embodiment will be described in detail. Note that the exemplary embodiments described below illustrate comprehensive or specific examples. Numerical values, shapes, materials, components, arrangements and connection modes of the components, steps, processes and the like illustrated in the following exemplary embodiments are merely examples, and are not intended to limit the present disclosure. Further, among the components in the following exemplary embodiments, components not recited in the independent claims are described as optional components.

In the present description, a term indicating the relationship between elements such as parallel, a term indicating the shape of an element such as rectangular, and a numerical range not only mean strict meanings but also include substantially equivalent relationship, for example, a relationship with deviation by a several percent.

The drawings are schematic views including emphasis, omission, and proportional adjustment as required to illustrate the present disclosure. These drawings are not strictly illustrated and may include shape, positional relationship, and percentage that differ from the actual ones. In the drawings, substantially identical configurations are denoted by the same reference mark, and duplicate description may be omitted or simplified.

In the present description, terms “upper” and “lower” used for a configuration of the all-solid-state battery do not refer to an upper direction (vertically upward) and a lower direction (vertically downward) in absolute space recognition, but are used as terms defined by a relative positional relationship based on the stacking order in a stacking configuration.

In the present description, a cross-sectional view illustrates a cross section taken at the central portion of the all-solid-state battery along a stacking direction. In the present description, the stacking direction is the same as the thickness direction of the layers of the all-solid-state battery and the normal direction of the principal surface of each layer of the all-solid-state battery.

### EXEMPLARY EMBODIMENT

### <Configuration>

### [A. All-Solid-State Battery]

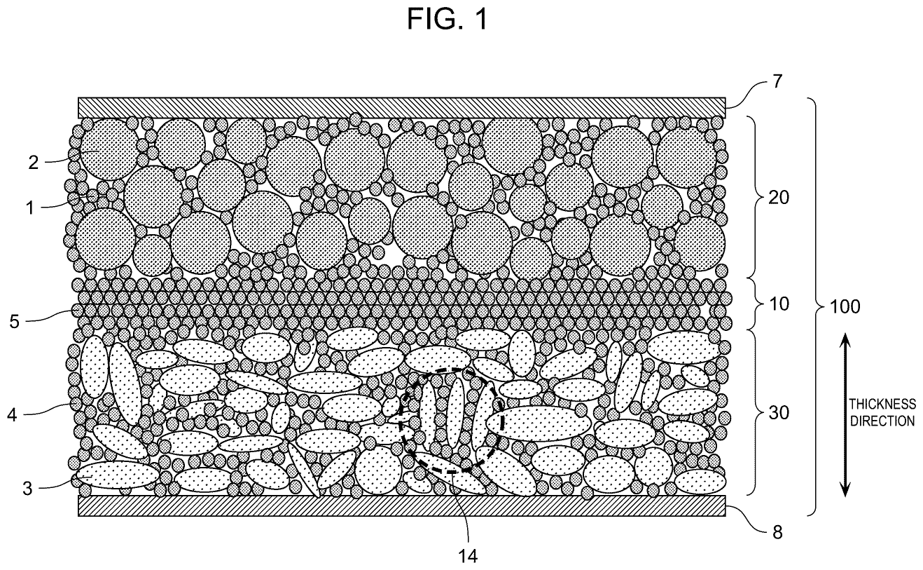

An outline of an all-solid-state battery according to a present exemplary embodiment will be described with reference to FIG. 1. FIG. 1 is a schematic view illustrating a cross section of all-solid-state battery 100 according to the present exemplary embodiment. All-solid-state battery 100 according to the present exemplary embodiment includes positive electrode current collector 7, negative electrode current collector 8, positive electrode layer 20 formed on a surface of positive electrode current collector 7 close to negative electrode current collector 8 and including positive electrode active material 2 and solid electrolyte 1, negative electrode layer 30 formed on a surface of negative electrode current collector 8 close to positive electrode current collector 7 and including negative electrode active material 3 and solid electrolyte 4, and solid electrolyte layer 10 disposed between positive electrode layer 20 and negative electrode layer 30 and including solid electrolyte 5. That is, all-solid-state battery 100 has a structure in which positive electrode current collector 7, positive electrode layer 20, solid electrolyte layer 10, negative electrode layer 30, and negative electrode current collector 8 are stacked in this order.

The negative electrode active material 3 in the present exemplary embodiment includes a plurality of flat active material particles having a flat shape. Each of a plurality of flat active material particles has a structure of a plurality of stacked pieces of graphite. In the present description, a particle being flat means that, for example, the aspect ratio (major radius/minor radius), which is the ratio of the length in the major axis direction (called major radius) to the length in the minor axis direction (called minor radius) of the particle, is two or more.

Negative electrode layer 30 has, in a cross section taken along the thickness direction thereof (or the stacking direction of all-solid-state battery 100), active material orientation region 14 in which two or more of a plurality of flat active material particles are adjacently oriented along the principal surface direction of negative electrode layer 30 (a direction orthogonal to the thickness direction of negative electrode layer 30). Hereinafter, a cross section of negative electrode layer 30 taken along the thickness direction thereof may be referred to as “negative electrode layer cross section”. In a negative electrode layer cross section, the major axis direction of each of the two or more flat active material particles in active material orientation region 14 are oriented at an angle of 0° or more and 30° or less with respect to the thickness direction of negative electrode layer 30. This angle is the smaller one among the angles between the major axis direction and the thickness direction. In active material orientation region 14, two or more flat active material particles are arranged, for example, along the minor axis direction of the flat active material particles. To facilitate penetration of lithium ions into the graphite constituting the flat active material particles, at least one of the two or more flat active material particles in active material orientation region 14 may have an aspect ratio of 3 or more. Furthermore, the aspect ratio may be, for example, 10 or less.

In the present description, the length in the major axis direction is the longest distance among the distances between two parallel lines touching the contour of a particle in a cross-sectional view such as a negative electrode layer cross section. The major axis direction is a direction orthogonal to the two parallel lines having the longest distance therebetween. The length in the minor axis direction is the distance along the direction orthogonal to the major axis direction among the distances between two parallel lines touching the contour of a particle in a cross-sectional view such as a negative electrode layer cross section. The minor axis direction is a direction orthogonal to the major axis direction.

In the present exemplary embodiment, solid electrolyte 5 is an example of the third solid electrolyte. Solid electrolyte 1 is an example of the first solid electrolyte. Solid electrolyte 4 is an example of the second solid electrolyte.

All-solid-state battery 100 in the present exemplary embodiment is formed, for example, by the following method. Positive electrode layer 20 is formed on positive electrode current collector 7 made of a metal foil, negative electrode layer 30 is formed on negative electrode current collector 8 made of a metal foil, and solid electrolyte layer 10 is formed to be between positive electrode layer 20 and negative electrode layer 30. Then, by pressing from the outer side of positive electrode current collector 7 and the outer side of negative electrode current collector 8 in the stacking direction, all-solid-state battery 100 is produced. The pressing pressure is, for example, 100 MPa or more and 1000 MPa or less. By the pressing, the filling rate of at least one of solid electrolyte layer 10, positive electrode layer 20, and negative electrode layer 30 is set to 60% or more and less than 100%. Note that, the detail of the method for producing all-solid-state battery 100 will be described later.

The filling rate of 60% or more results in less voids in solid electrolyte layer 10, positive electrode layer 20, or negative electrode layer 30, which allows high ion conduction and electron conduction to obtain good charge and discharge characteristics. Note that, the filling rate is a proportion of a volume occupied by materials not including voids between materials to the total volume.

For example, a terminal is attached to pressed all-solid-state battery 100, and all-solid-state battery 100 is housed in a case. As the case for all-solid-state battery 100, for example, a stainless steel (SUS), iron, or aluminum case, a resin case, or an aluminum laminated bag is used.

Hereinafter, solid electrolyte layer 10, positive electrode layer 20, and negative electrode layer 30 of all-solid-state battery 100 according to the present exemplary embodiment will be described in detail.

### [B. Solid Electrolyte Layer]

First, solid electrolyte layer 10 will be described. Solid electrolyte layer 10 according to the present exemplary embodiment includes solid electrolytes 5, and may further includes a binder.

### [B-1. Solid Electrolyte]

Solid electrolyte 5 according to the present exemplary embodiment will be described. Examples of the solid electrolyte material used for solid electrolyte 5 include non-organic solid electrolytes such as sulfide solid electrolytes, halide solid electrolytes, and oxide solid electrolytes, which are typically known materials. The solid electrolyte material has, for example, lithium ion conductivity. Any of sulfide solid electrolytes, halide solid electrolytes, and oxide solid electrolytes may be used as the solid electrolyte material. The type of the sulfide solid electrolyte according to the present exemplary embodiment is not particularly limited. Sulfide solid electrolytes include Li₂S—SiS₂, LiI—Li₂S—SiS₂, LiI—Li₂S—P₂S₅, LiI—Li₂S—P₂O₅, LiI—Li₃PO₄—P₂S₅, and Li₂S—P₂S₅. In particular, the sulfide solid electrolyte may include Li, P, and S from the viewpoint of obtaining excellent lithium ion conductivity. The sulfide solid electrolyte may include P₂S₅ to have high reactivity with a binder and high bonding capability to a binder. Note that, the description “Li₂S—P₂S₅” indicates a sulfide solid electrolyte made from a raw material composition including Li₂S and P₂S₅, and the same applies to other descriptions.

In the present exemplary embodiment, the sulfide solid electrolyte material is, for example, a sulfide glass ceramic including Li₂S and P₂S₅, and the ratio of Li₂S to P₂S₅ may be in a range by mol from 70:30 to 80:20 inclusive or in a range from 75:25 to 80:20 inclusive for Li₂S:P₂S₅. The ratio of Li₂S to P₂S₅ in these ranges can produce a crystal structure having high lithium ion conductivity while keeping a high lithium (Li) concentration which influences battery characteristics. The ratio of Li₂S to P₂S₅ in these ranges also readily secures the amount of P₂S₅ that reacts with and bonds to the binder.

Solid electrolytes 5 are composed of, for example, a plurality of particles. The average particle size of solid electrolyte 5 is smaller than, for example, the average particle size of negative electrode active material 3 (described later). This readily secures the contact area with negative electrode active material 3 in negative electrode layer 30.

The average particle size of solid electrolyte 5 is, for example, 0.2 μm or more and 10 μm or less. Accordingly, the contact surface with negative electrode active material 3 in negative electrode layer 30 is maintained while reducing particle interfaces in solid electrolyte layer 10 to keep resistance components low at the particle interfaces, and thus the lithium ion conductivity of the whole solid electrolyte layer 10 can be suppressed.

### [B-2. Binder]

The binder according to the present exemplary embodiment will be described. The binder has no lithium ion conductivity and electron conductivity and serves as a bonding material to bond materials in solid electrolyte layer 10 to each other and bond solid electrolyte layer 10 to another layer. Examples of the binder in the present exemplary embodiment may include a thermoplastic elastomer into which a functional group has been introduced to improve bonding strength. The functional group may be a carbonyl group, and the carbonyl group may be maleic anhydride from a viewpoint of improving bonding strength. An oxygen atom of maleic anhydride reacts with solid electrolyte 5 to bond solid electrolyte 5 to solid electrolyte 5 via the binder, and thereby forms a structure in which the binder is disposed between solid electrolyte 5 and solid electrolyte 5. As a result, the bonding strength improves.

For example, styrene-butadiene-styrene (SBS), or styrene-ethylene-butadiene-styrene (SEBS) is used as a thermoplastic elastomer. This is because these materials have high bonding strength, and high durability also in cycle characteristics of a battery. A thermoplastic elastomer to which hydrogen is added (hereinafter, referred to as hydrogenated) may be used. Use of a hydrogenated thermoplastic elastomer improves solubility in a solvent used for forming solid electrolyte layer 10 as well as reactivity and adhesion.

The added amount of the binder is, for example, 0.01% by mass or more and 5% by mass or less, may be 0.1% by mass or more and 3% by mass or less, or may be 0.1% by mass or more and 1% by mass or less. Adding the binder by 0.01% by mass or more readily causes bonding via the binder and thus sufficient bonding strength can be obtained. Adding the binder by 5% by mass or less suppresses deterioration in battery characteristics such as charge and discharge characteristics. What is more, for example, the charge and discharge characteristics in a low temperature region will not decreases easily even when physical properties such as hardness, tensile strength, and tensile elongation of the binder changes.

### [C. Positive Electrode Layer]

Next, positive electrode layer 20 according to the present exemplary embodiment will be described. Examples of positive electrode layer 20 according to the present exemplary embodiment includes solid electrolyte 1 and positive electrode active material 2. A conductive auxiliary agent, such as acetylene black and KETJENBLACK (registered trademark), and a binder may be added to positive electrode layer 20 as necessary to secure electron conductivity. Since too much amount added influences the battery performance, the added amount is desirably small as such that does not influence the battery performance.

The weight ratio of positive electrode active material 2 to solid electrolyte 1 is, for example, in the range from 50:50 to 95:5 inclusive, and may be in the range from 70:30 to 90:10 inclusive.

The volume ratio of positive electrode active material 2 to solid electrolyte 1 is, for example, in the range from 60:40 to 90:10 inclusive, and may be in the range from 70:30 to 85:15 inclusive. Such volume ratio readily secures both a lithium ion conduction path and an electron conduction path in positive electrode layer 20.

Positive electrode current collector 7 is made of, for example, a metal foil. For example, a metal foil of SUS, aluminum, nickel, titanium, or copper is used as the metal foil.

### [C-1. Solid Electrolyte]

The solid electrolyte material used for solid electrolyte 1 is, for example, at least one optionally selected from the solid electrolyte materials listed in [B-1. Solid electrolyte] described above. Although selection of the material is not particularly limited, a combination of materials is selected within such a scope that lithium ion conductivity is not significantly impaired, for example, at each interface where positive electrode active material 2 and solid electrolyte 1 are in contact with each other and each interface where solid electrolyte 1 and solid electrolyte 5 are in contact with each other. Solid electrolyte 1 is constituted by, for example, a plurality of particles.

### [C-2. Binder]

Since the binder is the same as the one described above, the description of the binder is omitted.

### [C-3. Positive Electrode Active Material]

Positive electrode active material 2 according to the present exemplary embodiment will be described. For example, a lithium-containing transition metal oxide is used as the material of positive electrode active material 2 according to the present exemplary embodiment. Examples of the lithium-containing transition metal oxide include LiCoO₂, LiNiO₂, LiMn₂O₄, LiCoPO₄, LiNiPO₄, LiFePO₄, LiMnPO₄, and compounds thereof of which transition metal is substituted with one or two different elements. As the compounds of which transition metal is substituted with one or two different elements, a known material such as LiNi_{1/3}Co_{1/3}Mn_{1/3}O₂, LiNi_{0.8}Co_{0.15}Al_{0.05}O₂, and LiNi_{0.5}Mn_{1.5}O₂ is used. A single type of the material of positive electrode active material 2 may be used or two or more types of the positive electrode active material 2 may be used in combination.

Positive electrode active material 2 is composed of a plurality of particles. Each particle of positive electrode active material 2 is a granulated particle in which a plurality of primary particles made of the above material are gathered. In the present description, the granulated particle is referred to as a particle of positive electrode active material 2.

The average particle size of positive electrode active material 2 is not particularly limited, but is, for example, 1 μm or more and 10 μm or less. In the particle size distribution of positive electrode active material 2, for example, 80% or more of all the particles are within a size range of +30% of the average particle size.

### [D. Negative Electrode Layer]

Next, negative electrode layer 30 according to the present exemplary embodiment will be described. Negative electrode layer 30 of the present exemplary embodiment includes solid electrolyte 4 and negative electrode active material 3. A conductive auxiliary agent, such as acetylene black and KETJENBLACK, and a binder may be added to negative electrode layer 30 as necessary to secure electron conductivity. Since too much amount added influences the battery performance, the added amount is desirably small as such that does not influence the battery performance. The ratio of negative electrode active material 3 to solid electrolyte 4 is, for example, by weight in the range from 95:5 to 40:60 inclusive, and may be in the range from 70:30 to 50:50 inclusive. The ratio of negative electrode active material 3 to solid electrolyte 4 is, for example, by volume in the range from 96:4 to 46:54 inclusive, and may be in the range from 75:25 to 56:44 inclusive. In other words, the volume ratio of negative electrode active material 3 to the total volume of negative electrode active material 3 and solid electrolyte 4 is, for example, 46% or more and 96% or less, and may be 56% or more and 75% or less. Such a volume ratio readily secures both a lithium ion conduction path which solid electrolyte 4 serves and an electron conduction path which negative electrode active material 3 in negative electrode layer 30 serves.

Negative electrode current collector 8 is made of, for example, a metal foil. For example, a metal foil of SUS, copper, and nickel is used as the metal foil.

[D-1. Solid electrolyte]

The solid electrolyte material used for solid electrolyte 4 is not particularly limited and is, for example, at least one optionally selected from the solid electrolyte materials listed in [B-1. Solid electrolyte]. The solid electrolyte material used for solid electrolyte 4 may be a sulfide solid electrolyte or a halide solid electrolyte from a viewpoint of easiness of forming covering layer 13 described later. Solid electrolyte 4 is composed of, for example, a plurality of particles. [D-2. Binder]

Since the binder is the same as the one described above, the description of the binder is omitted.

### [D-3. Negative Electrode Active Material]

Negative electrode active material 3 according to the present exemplary embodiment will be described. As a material of negative electrode active material 3 according to the present exemplary embodiment, a granulated carbon material (active material particle) formed of a plurality of stacked pieces of graphite is used. That is, negative electrode active material 3 includes a plurality of granulated active material particles. A known material and granulation method are used for the granulated active material particles. The granulated active material particle has a shape of, for example, a non-true spherical shape having a major axis direction and a minor axis direction. The granulated active material particles are pressed into flat active material particles in the production process of all-solid-state battery 100 as will be described in detail later.

As necessary, negative electrode active material 3 may further include a material of a known negative electrode active material such as SiOₓ, lithium, indium, tin, or silicon.

The average particle size of the granulated active material particles is not particularly limited, but is, for example, 1 μm or more and 15 μm or less. The particle size here is the maximum Feret's diameter, which is the maximum length of the sides of a rectangle circumscribing an active material particle in a planar image of the active material particle. The average particle size is a number average particle diameter, which is the number average of particle sizes obtained by the above method.

<Method for Producing all-Solid-State Battery>

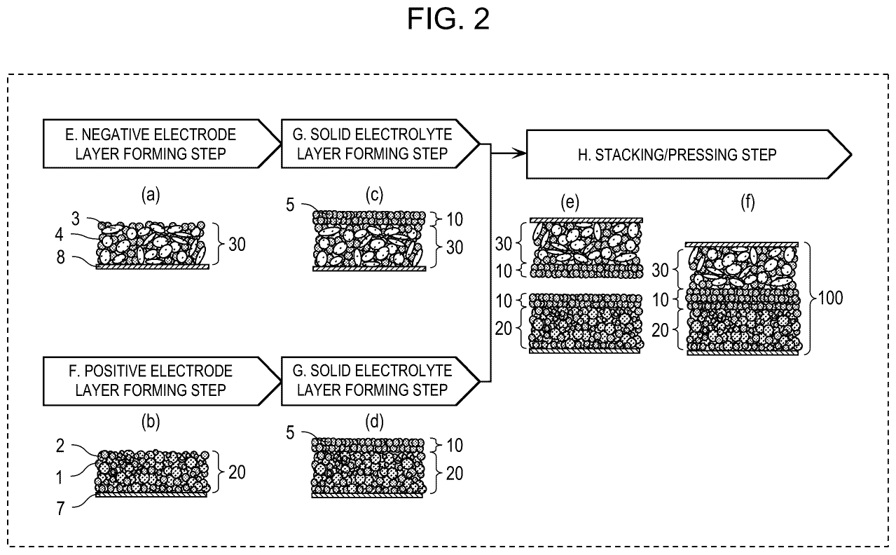

A method for producing all-solid-state battery 100 according to the present exemplary embodiment will be described with reference to FIG. 2. Specifically, the method for producing all-solid-state battery 100 including solid electrolyte layer 10, positive electrode layer 20, and negative electrode layer 30 will be described. FIG. 2 is a schematic cross-sectional view for explaining the method for producing all-solid-state battery 100.

The method for producing all-solid-state battery 100 includes, for example, a negative electrode layer forming step, a positive electrode layer forming step, a solid electrolyte layer forming step, a stacking step, and a pressing step. The negative electrode layer forming step is an example of a production step of negative electrode layer 30. In the negative electrode layer forming step (part (a) of FIG. 2), negative electrode layer 30 is formed on negative electrode current collector 8. In the positive electrode layer forming step (part (b) of FIG. 2), positive electrode layer 20 is formed on positive electrode current collector 7. In the solid electrolyte layer forming step (parts (c) and (d) of FIG. 2), solid electrolyte layer 10 is prepared. In the stacking step and the pressing step (parts (c) and (f) of FIG. 2), positive electrode layer 20 formed on positive electrode current collector 7, negative electrode layer 30 formed on negative electrode current collector 8, and prepared solid electrolyte layer 10 are stacked such that solid electrolyte layer 10 is disposed between positive electrode layer 20 and negative electrode layer 30, and are pressed from the outer side of positive electrode current collector 7 and the outer side of negative electrode current collector 8. Hereinafter, details of each step will be described.

### [E. Negative Electrode Layer Forming Step]

As the step of forming negative electrode layer 30 (negative electrode layer forming step) according to the present exemplary embodiment, there are, for example, the following two methods (1) and (2).

(1) The method for forming negative electrode layer 30 according to the present exemplary embodiment is, for example, a film forming step including a mixture preparing step, an applying step, and a coating film pressing step. Specifically, in the mixture preparing step, for example, negative electrode active material 3 and solid electrolyte 4 are subjected to pretreatment for agitation mixing to be described in detail later, the obtained mixed powder is dispersed in an organic solvent, and a binder and a conductive auxiliary agent (not illustrated), for example, are dispersed in the organic solvent as necessary to form a slurry negative electrode mixture. In the applying step, the obtained negative electrode mixture is applied on a surface of the negative electrode current collector 8, and drying and/or baking is conducted to remove the solvent from the obtained coating film by heat drying. Next, in the coating film pressing step, the dry coating film formed on negative electrode current collector 8 is pressed. Negative electrode layer 30 is produced by this film forming step.

The method of applying the slurry is not particularly limited, and examples thereof include, for example, known applying methods using a blade coater, a gravure coater, a dip coater, a reverse coater, a roll knife coater, a wire bar coater, a slot die coater, an air knife coater, a curtain coater, an extrusion coater, or a combination thereof.

The organic solvent used to form a slurry may be, for example, heptane, xylene, and toluene, but are not limited thereto. Such an organic solvent that does not chemically react with negative electrode active material 3 and solid electrolyte 4 may be appropriately selected.

The method of drying and/or baking is not particularly limited as long as the coating film is dried to remove the organic solvent therefrom. A known drying method or baking method using a heater or the like may be adopted. The method of pressing in the coating film pressing step is not particularly limited. A known pressing method using a pressing machine or the like may be adopted.

(2) Another method for forming negative electrode layer 30 according to the present exemplary embodiment is, for example, a production method by a film forming step including a mixture preparing step, a powder depositing step, and a powder pressing step. In the mixture preparing step, negative electrode active material 3 in a powder state (not yet turned into slurry) and solid electrolyte 4 are prepared, a binder and a conductive auxiliary agent (not illustrated) are prepared as necessary, and the prepared materials are subjected to agitation mixing while appropriate compressive force and shear force are applied to form a negative electrode mixture in which negative electrode active material 3 and solid electrolyte 4 are uniformly dispersed. Agitation mixing will be described in detail later. In the powder depositing step, the obtained powdered negative electrode mixture is uniformly deposited on negative electrode current collector 8 using, for example, a squeegee to form a deposited body. In the powder pressing step, the deposited body obtained in the powder depositing step is pressed to form a film.

Production including depositing of the powdered negative electrode mixture is advantageous in that there is no need of a drying step so that the production cost is low. Moreover, a solvent that may affect the battery performance of all-solid-state battery 100 will not remain after forming negative electrode layer 30. For example, since degradation of material caused by remaining solvent does not occur during charge and discharge of all-solid-state battery 100, the deterioration in the battery characteristics is suppressed. In the production step, there is no degradation of material caused by solvent since there is no solvent contained. Thus, the battery performance can be improved. When all-solid-state battery 100 is produced by a method including depositing of a powdered negative electrode mixture, for example, the concentration of solvent in negative electrode layer 30 is 50 ppm or less, that is, negative electrode layer 30 includes substantially no solvent component.

In either of the methods (1) and (2), it is important to perform a mixing step to perform dry agitation mixing of negative electrode active material 3 and solid electrolyte 4 for preparation for film-forming. The agitation mixing means a method of mixing negative electrode active material 3 and solid electrolyte 4 with compressive force and shear force applied. There is no other particular requirements. The purpose of the mixing step to perform agitation mixing is to form a covering film of densely compact particles of solid electrolyte 4 on a part of the surface of negative electrode active material 3. In particular, the granulated active material particles included in negative electrode active material 3 do not have a true spherical shape but each have a profile having a long length direction (that is, a major axis direction,) and a short length direction (that is, a minor axis direction). It is desirable to intentionally form more covering film at tips in the major axis direction of the granulated active material particle.

Hereinafter, the densely compact covering film at this stage in the production of the all-solid-state battery is referred to as covering layer 13.

A specific mixing procedure will be described later.

### [F. Positive Electrode Layer Forming Step]

In the step of forming positive electrode layer 20 (positive electrode layer forming step) according to the present exemplary embodiment, the basic film forming method is similar to the method of forming negative electrode layer 30 described in [E. Negative electrode layer forming step] except that a material used is changed to that for positive electrode layer 20.

The method for producing positive electrode layer 20 may be, for example, a method in which the positive electrode mixture obtained by mixing solid electrolyte 1, positive electrode active material 2, and, as necessary, a binder and a conductive auxiliary agent (not illustrated) into a slurry is applied onto positive electrode current collector 7, and then dried (that is, a method similar to the method (1) in [E. Negative electrode layer forming step]). Positive electrode layer 20 may be produced by, for example, a method of depositing powdered positive electrode mixture that is not yet turned into a slurry on positive electrode current collector 7 (that is, a method similar to the method (2) in [E. Negative electrode layer forming step]). In the step of forming positive electrode layer 20, a mixing step of agitation mixing may be or may not be performed.

Production using the method including depositing of the powdered positive electrode mixture is advantageous in that the drying step is unnecessary and the production cost is low. Moreover, a solvent that may affect the volume of the all-solid-state battery will not remain in formed positive electrode layer 20. That is, an effect similar to that of producing negative electrode layer 30 by the method (2) can be obtained.

### [G. Solid Electrolyte Layer Forming Step]

Solid electrolyte layer 10 according to the present exemplary embodiment can be produced by a method similar to [E. Negative electrode layer forming step] except that, for example, solid electrolyte 5 and, as necessary, a binder is dispersed in an organic solvent to form a slurry, and the obtained slurry is applied onto formed positive electrode layer 20 and/or formed negative electrode layer 30. As in the method (2), a film may be formed using the powdered material of solid electrolyte layer 10.

In the examples illustrated in parts (c) and (d) of FIGS. 2, solid electrolyte layer 10 is formed on positive electrode layer 20 and negative electrode layer 30, but the present invention is not limited to these examples. Solid electrolyte layer 10 may be formed on either positive electrode layer 20 or negative electrode layer 30. Alternatively, solid electrolyte layer 10 may be produced by the method described above on a base material such as a polyethylene terephthalate (PET) film, and obtained solid electrolyte layer 10 may be stacked on positive electrode layer 20 and/or negative electrode layer 30.

### [H. Stacking Step and Pressing Step]

In the stacking step and the pressing step, the layers respectively obtained in the film forming steps, that is, positive electrode layer 20 formed on positive electrode current collector 7, negative electrode layer 30 formed on negative electrode current collector 8, and solid electrolyte layers 10 are stacked such that solid electrolyte layer 10 is between positive electrode layer 20 and negative electrode layer 30 (stacking step), and then pressing is performed from the outer side of positive electrode current collector 7 and the outer side of negative electrode current collector 8 (pressing step) to obtain all-solid-state battery 100.

The purpose of pressing is to increase densities of positive electrode layer 20, negative electrode layer 30, and solid electrolyte layer 10. The increased density improves lithium ion conductivity and electron conductivity in positive electrode layer 20, negative electrode layer 30, and solid electrolyte layer 10, and thus all-solid-state battery 100 having good battery characteristics is obtained.

### <Method for Producing Negative Electrode Layer>

Hereinafter, a detailed exemplary production method pertaining to negative electrode layer 30 of all-solid-state battery 100 according to the present exemplary embodiment will be described, but the present invention is not limited to this exemplary production method. Unless otherwise specified, each step is performed, for example, inside a glove box inside which the dew point is controlled to −45° C. or less or inside a dry room. A method for producing negative electrode layer 30 by the method (2) will be described below, but similar negative electrode layer 30 can be produced by the method (1).

First, a material used for negative electrode layer 30 will be described. In the production of negative electrode layer 30, for example, a negative electrode mixture including negative electrode active material 3 and solid electrolyte 4 is used.

The material of negative electrode active material 3 is selected, for example, from the materials listed in [D-3. Negative electrode active material] in the description of the configuration of all-solid-state battery according to the present exemplary embodiment. The material of solid electrolyte 4 is selected, for example, from the materials listed in [B-1. Solid electrolyte].

The size of the material to be used will be specifically described. For negative electrode active material 3, for example, a material that has an average particle size of 8.0 μm and in which 80% or more of the whole particles have particle sizes within a range of +30% of the average particle size is used. For solid electrolyte 4, a particulate material having an average particle size of 0.5 μm or more and 1.0 μm or less is used.

The input amount of solid electrolyte 4 is appropriately selected within a range of the mixing ratio between negative electrode active material 3 and entire solid electrolyte 4, and the mixing ratio between negative electrode active material 3 and solid electrolyte 4 is, for example, 75:25 to 56:44 inclusive by volume ratio and 70:30 to 50:50 inclusive by weight ratio.

What is important in the production of negative electrode layer 30 is, for example, that a negative electrode mixture is produced through the mixing step in which agitation mixing is performed. Thus, in the production process of final negative electrode layer 30, a plurality of flat active material particles of which major axis direction is at an angle of 0° or more and 30° or less with respect to the thickness direction of negative electrode layer 30 become adjacent to each other as the active material particles of negative electrode active material 3 in negative electrode layer 30 are formed into flat active material particles.

Detail of a method for producing negative electrode layer 30 such as the mixing procedure for preparing the negative electrode mixture will be described below with comparison between the exemplary embodiment and a comparative example.

### (I) Method for Producing Negative Electrode Layer According to the Exemplary Embodiment

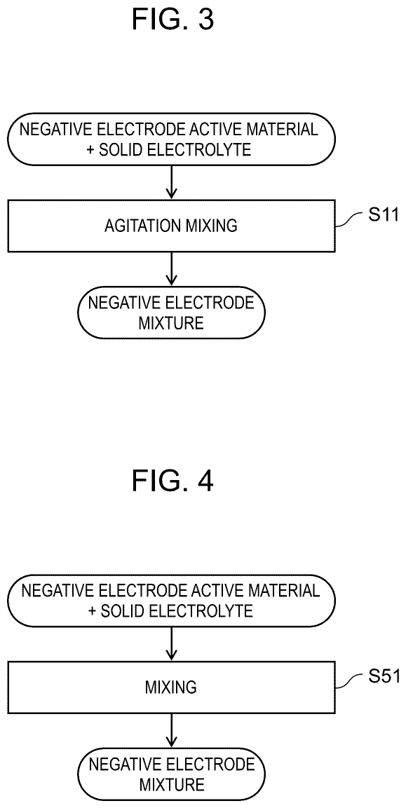

First, a method for producing a negative electrode layer according to the present exemplary embodiment will be described. FIG. 3 is a flowchart illustrating a method for producing a negative electrode mixture according to the exemplary embodiment.

When producing the negative electrode mixture according to the exemplary embodiment, the mixing step in which the particles of negative electrode active material 3 and the particles of solid electrolyte 4 are subjected to agitation mixing is performed (step S11). In the mixing step, negative electrode active material 3 including a plurality of non-true spherical active material particles is used. The agitation mixing here means mixing a material while applying compressive force and shear force to the material. For example, negative electrode active material 3 and solid electrolyte 4 are put into an agitation mixing device, and agitation mixing is performed by the agitation mixing device. As the agitation mixing device, for example, a device provided with a rotary blade for agitation mixing in a container into which a material is put is used. For example, the agitation mixing device has a predetermined space between the inner wall of a container and a rotary blade, and the rotating rotary blade applies compressive force and shear force to the material in the space. The agitation mixing is not limited to that using the above-described agitation mixing device. Any mixing in which compressive force and shear force are applied to the mixed material can be used.

By the agitation mixing of negative electrode active material 3 and solid electrolyte 4, dense covering layer 13 of solid electrolyte 4 can be formed at major axis directional ends of the granulated active material particles of negative electrode active material 3. Details of covering layer 13 will be described later. By this mixing step, a negative electrode mixture including the active material particles of negative electrode active material 3 having covering layer 13 formed on the surface thereof is obtained.

Next, using the formed negative electrode mixture, for example, negative electrode layer 30 is formed by the method (2) of [E. Negative electrode layer forming step] described above. All-solid-state battery 100 according to the exemplary embodiment is produced by the method described above using negative electrode layer 30. The production step is not particularly limited except for the mixing procedure of the negative electrode mixture.

### (II) Method for Producing Negative Electrode Layer According to a Comparative Example

Next, a method for producing negative electrode layer 30 according to a comparative example will be described. FIG. 4 is a flowchart illustrating a method for producing a negative electrode mixture according to the comparative example.

In the production method of the negative electrode mixture according to the comparative example, the particles of negative electrode active material 3 and the particles of solid electrolyte 4 are mixed (step S51). The mixing in step S51 is different from step S11 in that substantially neither compressive force nor shear force are applied to negative electrode active material 3 and solid electrolyte 4. The negative electrode mixture is obtained in such a manner. In the comparative example, the material of the negative electrode mixture is not subjected to agitation mixing, so that no covering layer 13 is formed on the surface of the active material particles of negative electrode active material 3.

Next, using the formed negative electrode mixture, for example, negative electrode layer 30 is formed by the method (2) of [E. Negative electrode layer forming step] described above. An all-solid-state battery according to the comparative example is produced by the method described above using negative electrode layer 30. The production step is not particularly limited except for the mixing procedure of the negative electrode mixture.

### (III) Structures of Negative Electrode Mixture and Negative Electrode Layer

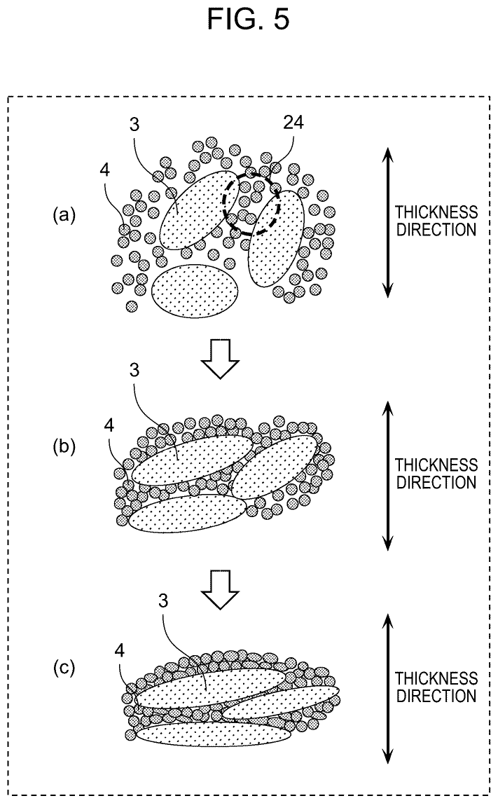

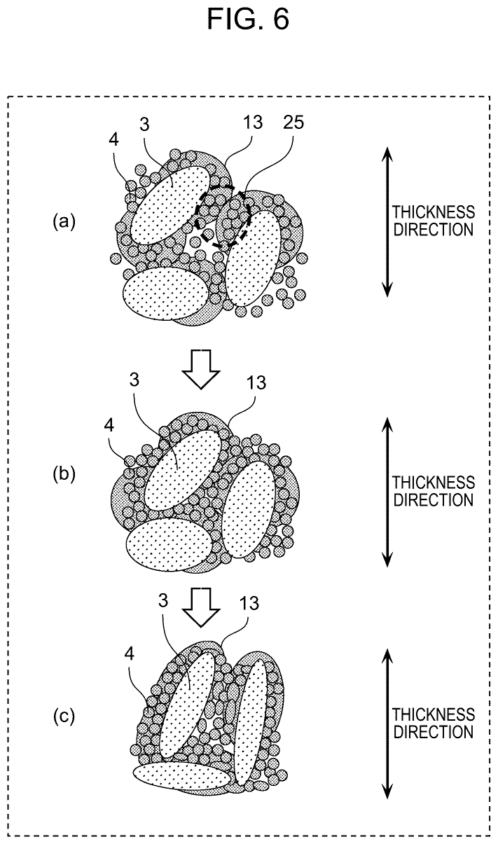

Next, structures of the negative electrode mixture and negative electrode layer 30 formed using the negative electrode mixture according to each of the exemplary embodiment and the comparative example will be described. Specifically, how the states of negative electrode active material 3 including non-true spherical active material particles having major axis direction and minor axis direction and solid electrolyte 4 change will be described with reference to FIGS. 5 and 6. FIG. 5 is a schematic view for explaining the change in the states of negative electrode active material 3 and solid electrolyte 4 according to the comparative example. FIG. 6 is a schematic view for explaining the change in the states of negative electrode active material 3 and solid electrolyte 4 according to the exemplary embodiment. Specifically, each of part (a) of FIG. 5 and part (a) of FIG. 6 is a schematic view of an area including several particles of negative electrode active material 3 of the negative electrode mixture, illustrating the state during mixing or after agitation mixing just before the powder pressing step is performed. Part (b) of FIG. 5 and part (b) of FIG. 6 are schematic views of the negative electrode mixtures respectively illustrated in part (a) of FIG. 5 and part (a) of FIG. 6 under the pressing process in the powder pressing step. Part (c) of FIG. 5 and part (c) of FIG. 6 are each a schematic view illustrating negative electrode active material 3 in negative electrode layer 30 after the powder pressing step.

In the negative electrode mixture in the comparative example, as illustrated in part (a) of FIG. 5, the active material particles of negative electrode active material 3 having a major axis direction and a minor axis direction and the particles of solid electrolyte 4 are uniformly dispersed. Since the particle size of solid electrolyte 4 is smaller than the particle size of negative electrode active material 3, solid electrolyte 4 is deposited between adjacent active material particles of negative electrode active material 3 (for example, particles in dotted line region 24 in part (a) of FIG. 5) with low bulk density, that is, with many spaces.

Subsequently, in the process of pressing in the powder pressing step, the space between the particles of solid electrolyte 4 in dotted line region 24 shrinks while pressing is made along the thickness direction of negative electrode layer 30. During the pressing, as illustrated in part (b) of FIG. 5, solid electrolyte 4 in dotted line region 24 cannot support negative electrode active material 3, so that the active material particles of negative electrode active material 3 are overturned toward the horizontal direction in FIG. 5, that is, significantly tilt with respect to the thickness direction of negative electrode layer 30 while being pressed. As a result, in negative electrode layer 30 as illustrated in part (c) of FIG. 5, pressure is applied with negative electrode active material 3 lying along a planar direction (the direction perpendicular to the thickness direction of negative electrode layer 30). By the pressing, the non-true spherical active material particles are compressed in the minor axis directions thereof to deform into flat active material particles.

In contrast, as illustrated in part (a) of FIG. 6, in the negative electrode mixture according to the exemplary embodiment, at least partially on the surface of the active material particles of negative electrode active material 3, in particular, near the major axis directional ends of two or more adjacent active material particles, the particles of solid electrolyte 4 are pressed to form densely compact covering layer 13. With covering layer 13 on the surface of the active material particle, solid electrolyte 4 is deposited between the adjacent active material particles of negative electrode active material 3 (for example, the particles in dotted line region 25 in part (a) of FIG. 6) with high bulk density, that is, with less spaces.

Next, in the pressing process of the powder pressing step as illustrated in part (b) of FIG. 6, even when pressing is applied in the thickness direction of negative electrode layer 30, covering layers 13 support each other to suppress overturning of the active material particles of negative electrode active material 3 to tilt with respect to the thickness direction of negative electrode layer 30. Therefore, as illustrated part (c) of FIG. 6, the active material particles of negative electrode active material 3 are less likely to be overturned in negative electrode layer 30 that has finally been formed by the powder pressing step. As a result, the flat active material particle formed from an active material particle to have a minor axis direction is oriented such that the major axis direction of the flat active material particle is along the longitudinal direction (the thickness direction of negative electrode layer 30).

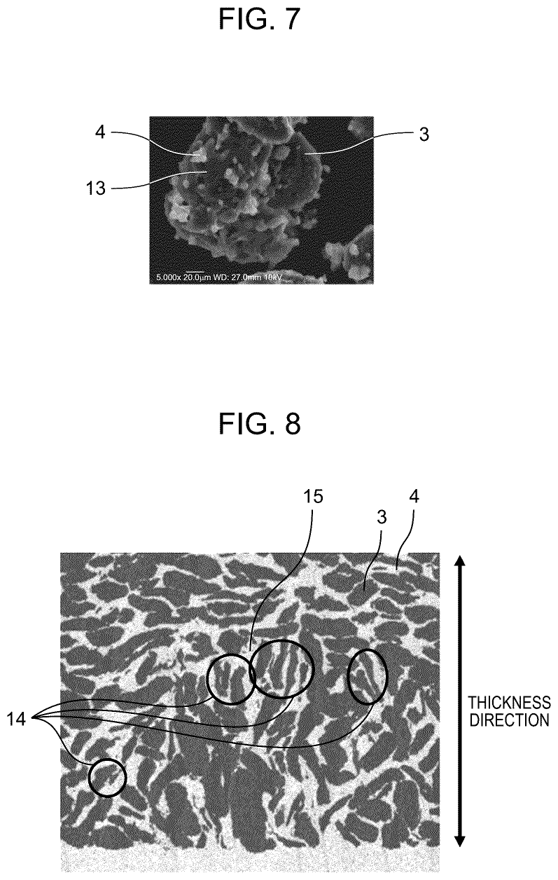

Now, the observed result of a negative electrode mixture and a negative electrode layer actually produced using the method described above will be described with reference to FIGS. 7 and 8. FIG. 7 is an electron microscope image showing an appearance of a negative electrode mixture according to the exemplary embodiment. FIG. 7 shows the observed result of the negative electrode mixture in a state illustrated in part (a) of FIG. 6. FIG. 8 is an electron microscope image showing a cross section of negative electrode layer 30 according to the exemplary embodiment. FIG. 8 shows a cross section taken along the thickness direction of negative electrode layer 30 formed from the negative electrode mixture shown in FIG. 7. That is, FIGS. 7 and 8 show the states of negative electrode active material 3 and solid electrolyte 4 described with reference to FIG. 6.

As can be seen in FIG. 7, covering layer 13 formed from compressed and compact particles of solid electrolyte 4 is formed on the surface of negative electrode active material 3 by the method for producing negative electrode mixture according to the present exemplary embodiment. In some part exists not-densified solid electrolyte 4 in a form of particles. Existence of such particles is allowed within such a range that manifests the effect described in FIG. 6. As can be seen in FIG. 8, active material orientation regions 14 in which two or more flat active material particles of the negative electrode active material are adjacently oriented along the principal surface direction of negative electrode layer 30 is formed in negative electrode layer 30 from the negative electrode mixture prepared by the production method according to the present exemplary embodiment. The major axis direction of each of the two or more flat active material particles of negative electrode active material in active material orientation region 14 are oriented at an angle of 0° or more and 30° or less with respect to the thickness direction of negative electrode layer 30. As in FIG. 8, negative electrode layer 30 may have a plurality of active material orientation regions 14.

In a negative electrode layer cross section, negative electrode layer 30 has solid electrolyte region 15 which is adjacent to active material orientation region 14 and does not include negative electrode active material 3 but includes solid electrolyte 4. That is, solid electrolyte region 15 including no negative electrode active material 3 is formed in negative electrode layer 30. Solid electrolyte 4 in solid electrolyte region 15 is formed from, for example, covering layer 13. In any negative electrode layer cross section of negative electrode layer 30, the area occupied by solid electrolyte region 15 may be, for example, 1.5 times or more or 2.0 times or more of the average area occupied by a single flat active material particle of two or more flat active material particles of negative electrode active material 3 in active material orientation region 14. Solid electrolyte region 15 may not be formed in negative electrode layer 30.

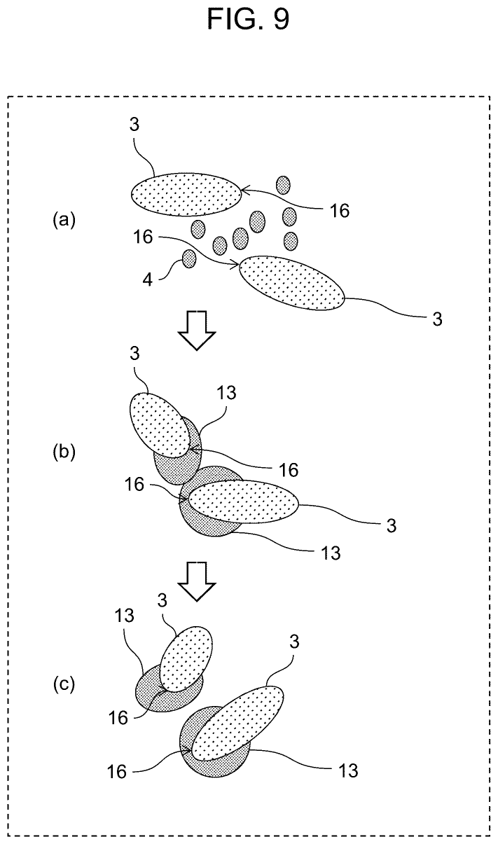

Next, a concept of intentionally producing the negative electrode mixture described in part (a) of FIG. 6 and FIG. 7, that is, a structure in which covering layer 13 of densely compact particles of solid electrolyte 4 is formed on at least a part of the surface of the active material particles of negative electrode active material 3, particularly at and near the major axis directional ends of the active material particles will be described. Specifically, the state of negative electrode active material 3 and solid electrolyte 4 under the agitation mixing in the mixing process shown in FIG. 3 will be described with reference to FIG. 9. FIG. 9 is a schematic view for explaining the state changes of negative electrode active material 3 and solid electrolyte 4 in the mixing step according to the exemplary embodiment.

As illustrated in part (a) of FIG. 9, negative electrode active material 3 and solid electrolyte 4 are prepared, and agitation mixing in which compressive force and shear force are applied while mixing is started. When the agitation mixing is started, as illustrated in part (b) of FIG. 9, solid electrolyte 4 at and near major axis directional ends 16 of the active material particles of negative electrode active material 3 is crushed by compression and shear between adjacent active material particles of negative electrode active material 3 to form covering layer 13. Next, as illustrated part (c) of FIG. 9, since the entire material is being agitated, the active material particles of negative electrode active material 3 rotate, and thus the intersection of major axes becomes moderate, which causes rapid decrease in the compressive and shear forces acting on ends 16, whereby dense covering layers 13 formed from solid electrolyte 4 are fixed at and near ends 16. This can be achieved by adjusting material-based factors (particle size, material, shape, etc.) and process conditions (amount of input material, method of applying compressive and shear forces, temperature, etc.) of agitation mixing. The method for producing negative electrode mixture is not particularly limited to the method of forming dense covering layer 13 from solid electrolyte 4 at and near major axis directional ends 16 of the active material particles of negative electrode active material 3.

### EXAMPLES

Next, the results of evaluating the battery characteristics of all-solid-state battery 100 according to the present disclosure will be described using examples, but the present disclosure is not limited to the examples. Specifically, all-solid-state batteries in Example 1 and Comparative Example 1 were formed, and the battery characteristics of the formed all-solid-state batteries were evaluated.

[Preparation of all-Solid-State Battery]

### (I) Example 1

Negative electrode layer 30 was formed using the method described in “(I) Method for producing negative electrode layer according to the exemplary embodiment” described above. The mixing ratio of negative electrode active material 3 and solid electrolyte 4 was 70:30 in volume ratio.

Then, all-solid-state battery 100 according to Example 1 was produced through the positive electrode layer forming step, the solid electrolyte layer forming step, the stacking step, and the pressing step described in <Method for producing all-solid-state battery> above.

### (II) Comparative Example 1

An all-solid-state battery according to Comparative Example 1 was produced in a manner similar to that of the all-solid-state battery according to Example 1 described above, except that a negative electrode layer was formed using the method described in “(II) Method for producing negative electrode layer according to comparative example”. The mixing ratio of negative electrode active material 3 and solid electrolyte 4 was 70:30 in volume ratio.

### [Evaluation of Battery Capacity]

Next, the battery characteristics of the all-solid-state batteries according to Example 1 and Comparative Example 1 produced above were evaluated. Specifically, Table 1 shows the results of evaluating the charge-discharge efficiency as the battery characteristics as an index of the battery capacity. The charge-discharge efficiency was evaluated under two conditions of low-rate discharge and high-rate discharge. In the evaluation of the charge-discharge efficiency, charge was performed under the condition of a final voltage of 3.7 V, a current rate of 0.05 C, and a temperature of 25° C. Discharge was performed under the conditions of a final voltage of 1.9 V, a charge rate of 0.05 C for of low rate, a charge rate of 1 C for high rate, and a temperature of 25° C. In the evaluation of the charge-discharge efficiency, charge was first conducted, and the ratio (%) of the discharge capacity to the charge capacity was calculated as the charge-discharge efficiency.

TABLE 1

| | Comparative | |
|---|---|---|
| | Example 1 | Example 1 |
| Charge-discharge efficiency | 99% | 99% |
| in low-rate discharge | | |
| Charge-discharge efficiency | 33% | 64% |
| in high-rate discharge | | |

Table 1 shows that all-solid-state battery 100 according to Example 1 has improved charge-discharge efficiency than the all-solid-state battery according to Comparative Example 1. In Example 1, the charge-discharge efficiency at high-rate discharge is improved as compared with Comparative Example 1. The improvement of battery characteristics is considered to be the result of producing all-solid-state battery 100 with intentionally forming covering layer 13 at and near major axis directional ends 16 of active material particles of negative electrode active material 3. Specifically, when the major axis direction of flat active material particles is significantly overturned (that is, oriented along the direction along the principal surface) in negative electrode layer 30, lithium ion conduction in the thickness direction of negative electrode layer 30 is hindered by the flat active material particles. In all-solid-state battery 100 according to the example, active material orientation region 14 in which two or more flat active material particles of negative electrode active material 3 are oriented along the thickness direction of negative electrode layer 30 is formed, and this is considered to readily secure a lithium ion conduction path in the thickness direction of negative electrode layer 30 even in high-rate discharge.

In addition, the presence of active material orientation region 14 in which the major axis directions of the flat active material particles are not significantly overturned in negative electrode layer 30 allows distribution of stress produced by expansion and contraction of negative electrode active material 3 by charge and discharge also in a direction intersecting the thickness direction of negative electrode layer 30, which may manifest improved durability. Furthermore, in negative electrode layer 30, there is solid electrolyte region 15 that is composed of solid electrolyte 4 formed from covering layer 13 and has no negative electrode active material 3, and thus an effect of further relaxing the stress by solid electrolyte 4 softer than negative electrode active material 3 may be manifested. The stress relaxation suppresses peeling at an interface between negative electrode active material 3 and solid electrolyte 4 and peeling at an interface between negative electrode layer 30 and solid electrolyte layer 10 to suppress the reduction in battery capacity.

In the present exemplary embodiment, the volume ratio of negative electrode active material 3 to the total volume of negative electrode active material 3 and solid electrolyte 4 in negative electrode layer 30 is, for example, 46% or more and 96% or less. With such a volume ratio of negative electrode active material 3, the effects described with the examples are readily obtained. Specifically, the volume ratio of 96% or less can increase covering layer 13 formed at end 16 of the active material particle of negative electrode active material 3, and thus active material orientation region 14 in negative electrode layer 30 can be increased. The volume ratio of 46% or more can further increase the capacity of the battery. From the viewpoint of further increasing the capacity of the battery at high-rate charge and discharge, the volume ratio may be 56% or more and 75% or less.

### Other Exemplary Embodiments

While the all-solid-state battery according to the present disclosure has been described above based on the exemplary embodiments, the present disclosure is not limited to the above-described exemplary embodiments. Embodiments that are various modifications of the exemplary embodiments conceivable by those skilled in the art, and other embodiments constructed by combining some components of the exemplary embodiments are also included in the scope of the present disclosure without departing from the gist of the present disclosure.

For example, in the above exemplary embodiments, an example in which conducting ions in all-solid-state battery 100 are lithium ions has been described, but the present disclosure is not limited thereto. The conducting ions in all-solid-state battery 100 may be ions other than lithium ions, such as sodium ions, magnesium ions, potassium ions, calcium ions, or copper ions.

According to the all-solid-state battery and the like according to one aspect of the present disclosure, reduction in battery capacity in the all-solid-state battery can be suppressed.

### INDUSTRIAL APPLICABILITY

The all-solid-state battery according to the present disclosure is expected to be applied to various batteries such as a power supply for mobile electronic devices and an in-vehicle battery.

### REFERENCE MARKS IN THE DRAWINGS

1, 4, 5: solid electrolyte
2: positive electrode active material
3: negative electrode active material
7: positive electrode current collector
8: negative electrode current collector
10: solid electrolyte layer
13: covering layer
14: active material orientation region
15: solid electrolyte region
16: end
20: positive electrode layer
30: negative electrode layer
100: all-solid-state battery

1. An all-solid-state battery comprising:
a positive electrode current collector;
a positive electrode layer including a positive electrode active material and a first solid electrolyte;
a solid electrolyte layer including a third solid electrolyte;
a negative electrode layer including a negative electrode active material and a second solid electrolyte; and
a negative electrode current collector, wherein
the positive electrode current collector, the positive electrode layer, the solid electrolyte layer, the negative electrode layer, and the negative electrode current collector are stacked in this order,
the negative electrode active material includes a plurality of flat active material particles each having a structure of a plurality of stacked pieces of graphite,
the negative electrode layer has an active material orientation region including two or more flat active material particles, among the plurality of flat active material particles, which are adjacently oriented along a thickness direction of the negative electrode layer in a cross section of the negative electrode layer, and
in the cross section, an angle between a major axis direction of each of the two or more flat active material particles and the thickness direction of the negative electrode layer is 0° or more and 30° or less.

2. The all-solid-state battery according to claim 1, wherein the negative electrode layer further includes a solid electrolyte region not including the negative electrode active material but including the second solid electrolyte, and
the solid electrolyte region is located adjacent to the active material orientation region in the cross section, and has an area of 1.5 times or more of an average area of the two or more flat active material particles in the cross section.

3. The all-solid-state battery according to claim 1, wherein in the cross section, an aspect ratio that is a ratio of a length in a major axis direction to a length in a minor axis direction of at least one flat active material particle among the two or more flat active material particles is three or more.

4. The all-solid-state battery according to claim 1, wherein a volume ratio of the negative electrode active material to a total volume of the negative electrode active material and the second solid electrolyte in the negative electrode layer is 46% or more and 96% or less.

5. The all-solid-state battery according to claim 4, wherein the volume ratio of the negative electrode active material to the total volume of the negative electrode active material and the second solid electrolyte in the negative electrode layer is 56% or more and 75% or less.

6. The all-solid-state battery according to claim 1, wherein a concentration of a solvent contained in the negative electrode layer is 50 ppm or less.

7. A method for producing the all-solid-state battery according to claim 1, wherein a production step of producing the negative electrode layer includes a mixing step of mixing the negative electrode active material and the second solid electrolyte, the mixing step including forming of a covering layer made of the second solid electrolyte using the negative electrode active material including a plurality of active material particles each having a major axis direction and a minor axis direction, having a non-true spherical shape, and having been granulated from a plurality of stacked pieces of graphite, the covering layer covering a major axis directional end of two or more of the plurality of active material particles.

8. The method for producing the all-solid-state battery according to claim 7, wherein the mixing step is a step of mixing the negative electrode active material and the second solid electrolyte with compressive force and shear force being applied to the negative electrode active material and the second solid electrolyte.
